(19) United States
(12) Patent Application Publication
(10) Pub. No.: US 2024/0316740 A1
(43) Pub. Date: Sep. 26, 2024

(54) Tool

(71) Applicant: Rosemarie Liedtke, Pinnow (DE)

(72) Inventor: Karsten Liedtke, Bouzonville (FR)

(21) Appl. No.: 18/519,670

(22) Filed: Nov. 27, 2023

(30) Foreign Application Priority Data
Mar. 24, 2023 (DE) 20 2023 101 488.7

(51) Int. Cl. B25D 1/16; B21D 1/06; B25D 1/02

(52) U.S. Cl. CPC B25D 1/16; B21D 1/065; B25D 1/02

(57) ABSTRACT

The present invention relates to a tool (1) comprising
a handle element (101),
a rod (103) which is firmly received in the handle element (101) and has a second stop (103a) at its end opposite the handle element (101),
a weight (105) slidingly guided on the rod (103), which has a third stop (105a) on its side facing the handle element (101) and a fourth stop (105b) in its interior,
   wherein the handle element (101) has a first stop (101a) at its end facing the weight (105), so that the weight (105) can be struck with its third stop (105a) against the first stop (101a) and alternatively with its fourth stop (105b) against the second stop (103a).

### FIELD OF THE INVENTION

The present invention relates to a tool with two striking directions for use as a hammer and as a pulling hammer.

### DISCUSSION OF THE PRIOR ART

Tools, especially hammers, have been used for forming materials for a long time. The force is transmitted in an impulsive manner through an impacting movement with which the hammer strikes the material. When using pulling hammers, also known as draw hammers or slide hammers, the force is not transferred directly to the workpiece by the striking motion, as is the case with the classic hammer. The swinging motion of the classic hammer is replaced by a pulling motion of a weight mounted on a rod. This rod is connected to the structure on the workpiece side and has a stop point at the other end. This movement of the weight on the rod is decelerated like a pulse when the weight hits the stop point. By transmitting the impulse force exerted, the force effect takes place at the end of the rod on the workpiece side.

There are a number of pulling hammers available on the market from various manufacturers. However, they are all based on the principle described above, which is disclosed in DE 20 2011 004 262 U1, among others. In addition to the above functional principle, a handle is provided on the rod, with which the rod can be held and guided precisely in position on the workpiece. DE 20 2011 004 262 U1 also discloses a stand and describes this adjustable stop, which is considered to be state of the art, with the aid of a spring. Furthermore, the path length of the rod available for guiding the weight is adjustable. DE 20 2017 002 407 U1 discloses a pull hammer whose weight (pull pulse generator) and the grip piece located on the workpiece side are connected with a rubber band.

Although each known solution is described as advantageous in itself, there are disadvantages when using the known pull hammers. During use, bruising of parts of the hand is occasionally observed when the weight hits the handle element or the base, which acts as a stop point. In addition, it is not yet possible to use a single tool to reshape material, for example to set a bead, in confined, difficult-to-access spaces. In this case, the material is traditionally formed with a chisel and careful hammer blows, or directly with a hammer if the installation space is large enough and the available area is large enough. This means that two tools are usually required, which are difficult to use if the installation space is small.

Consequently, there is a need for a new type of tool that can be used flexibly.

### BRIEF SUMMARY OF THE INVENTION

The present invention is therefore based on the task of overcoming the disadvantages of the prior art and providing a tool that can be used as a hammer with a significantly reduced risk of dislocation on the one hand and as an improved pulling hammer on the other hand, with a small installation space and the desired localised force effect.

The aforementioned task is solved in a first aspect of the present invention by a tool (1) comprising
a handle element (101),
a rod (103) which is firmly received in the handle element (101) and has a second stop (103a) at its end opposite the handle element (101),
a weight (105) slidingly guided on the rod (103), which has a third stop (105a) on its side facing the handle element (101) and a fourth stop (105b) in its interior,
   wherein the handle element (101) has a first stop (101a) at its end facing the weight (105), so that the weight (105) can be struck with its third stop (105a) against the first stop (101a) and alternatively with its fourth stop (105b) against the second stop (103a).

The “handle element” (101) according to the present invention is used to hold the tool (1) with one hand on or near the workpiece to be machined. For this purpose, the handle element (101) preferably has grooves or recesses which make it easier to grip.

According to the present invention, “stop” refers to the intended end point of the movement of the corresponding elements of the tool (1), whereby here the first stop (101a) and the third stop (105a) as well as the second stop (103a) and the fourth stop (105b) each form half of a positive fit for optimum force transmission.

The weight (105) is held with the second hand and slid back and forth on the rod (103) in order to transfer force by striking the corresponding stops. Since the weight (105) itself is a type of handle, it also preferably has grooves or indentations that make it easier to grip.

The tool (1) according to the invention has the general advantage that a second direction of impact is possible with a single tool, which is particularly useful in tight installation spaces. Thus, the tool (1) according to the invention can be used both as a pulling hammer and as a hammer.

In a further development of the tool (1) according to the invention, the first stop (101a) is concealed inside the handle element (101).

In contrast to the known solutions, the concealed first stop (101a), on which the third stop (105a) strikes, considerably reduces the risk of injury, for example by bruising, since, for example, the skin of the hand holding the handle element (101) cannot be pinched or can only be pinched very slightly. This effect is further favoured by the fact that the handle element (101) and the weight (105) are designed on the outside at the points that are gripped by skilled personnel in the trade for use in such a way that a secure grip is made possible and slipping is impossible.

One embodiment of the tool (1) according to the invention provides that the weight (105) is tapered on its side facing the handle element (101), so that it is at least partially received in a recess of the handle element (101) when it strikes the first stop (101a).

On the one hand, this further reduces the above-mentioned risk of injury and, on the other hand, the handle element (101) and weight (105) are securely guided and can be stored in the pushed-together state without the ingress of dirt that would hinder sliding on the rod (103). A further advantage lies in the fact that by at least partially accommodating the weight (105) in the handle element (101), the extension length of the tool (1) according to the invention is increased in relation to its compact length.

In order to be able to adjust the impact hardness of the tool (1) according to the invention within certain limits, it has been found to be advantageous in another further development if the tool (1) further comprises a spring (107) which is accommodated inside the weight (105), the pretension of the spring (107) being adjustable for the impact hardness of the weight (105) by rotating the weight (105).

According to the state of the art, the pretension of a spring could already be adjusted, but either an additional hand tool had to be used or both hands were required to twist a multi-part weight against each other. It was not possible to change the pretension and therefore the impact hardness during actual use.

With the present invention in this embodiment, the pretension of the spring (107) can be changed by turning the weight (105) relative to the fixed rod (103) with one hand, without having to remove the second hand from the handle element (101). This makes it possible in an advantageous way to adjust the impact hardness to the requirements while the tool (1) according to the invention is in use, even in a confined installation space. In principle, the tool (1) according to the invention no longer needs to be removed from the workpiece to be machined for this purpose.

It has proven to be advantageous for the manageability of the tool (1) according to the invention if, in a special embodiment, the handle element (101) has a funnel-shaped widening (1011) at its end facing the weight (105). This funnel-shaped widening (1011) serves on the one hand to prevent the hand from slipping on the handle element (101) when the tool (1) according to the invention is held there. On the other hand, the funnel-shaped widening (1011) serves as a recessed grip for the thumb of a hand when the tool (1) according to the invention is guided with one hand and held by the weight (105). The latter use is described below.

Another further development of the tool (1) according to the invention provides that it further comprises a receiving device (109) arranged on the handle element (101), which is orientated towards a workpiece to be treated.

Various processing inserts required for machining a workpiece can be mounted in this receiving device (109) provided in accordance with the invention. Since the tool (1) according to the invention can be used both as a pulling hammer and as a hammer, the receiving device (109) further extends the application possibilities.

In a particularly preferred embodiment, the receiving device (109) accommodates processing inserts which can be attached to contact points of a structure to be dented out in order to transmit force from the tool (1) according to the invention, so that the tool (1) acts as a pulling hammer. For example, various adhesive cover adapters attached to a structure to be dented out can be fastened in this receiving device (109).

In an alternative embodiment to the above embodiment, it is particularly preferred that the receiving device (109) accommodates processing inserts which can be attached to a structure to be deformed in order to transmit force from the tool (1), so that the tool (1) acts as a hammer. Various types of chisels, for example for inserting beads, can be fastened in this receiving device (109). There is no need for a place to carry out a hammer swing.

A special embodiment of the tool (1) according to the invention provides that the receiving device (109) accommodates a processing insert designed as a flexible knife, which is designed to be inserted into a bond or cementing between two body parts by means of the impact function and pulled out again by means of the pulling function, so that the bond or cementing can be released.

This special embodiment enables very simple and energy-saving loosening of bonding or cementing between two body parts, for example between a lower beam and an upper panel. The flexible design of the knife blade, which can be applied in different lengths, makes it easy to apply even in places that are difficult to access. The impact function of the tool according to the invention (1) is used to insert the knife into the bonding or cementing. Since conventional knives often get stuck there, it is an advantage of the invention that the knife can also be pulled out again very easily using the pull function of the tool (1) according to the invention in order to reattach it to the next bonded or cemented area. In this particular embodiment, the striking function as a hammer and the pulling function as a pulling hammer are advantageously combined.

These two alternative embodiments significantly extend the field of application of the tool (1) according to the invention and offer two essential basic functions in one tool.

For a long service life and easy handling, it has proven to be advantageous if the weight (105) has linear ball bearings in order to slide on the rod (103) with optimised friction.

Finally, the present invention presents a further embodiment in which the tool (1) has a closed flat end (111) at the outer end of the weight (105).

This closed flat end (111) serves, among other things, to set up the tool (1) according to the invention so that it cannot tip over. In addition, the outer end of the weight (105) can be widened in the shape of a funnel, so that on the one hand the hand is prevented from slipping and on the other hand the contact surface is increased.

This embodiment of the funnel-shaped widening can be further developed in such a way that the closed flat end (111) has a rubber coating. This prevents damage to the tool (1) according to the invention on the one hand and to its storage or installation location on the other.

A further embodiment of the tool (1) according to the invention provides that the spring (107) accommodated inside the weight (105) is in operative connection with the rod (103), so that a restoring spring force can be generated when the weight (105) is deflected on the rod (103) relative to the handle element (101).

Specifically, the spring (107), which is compressed by the weight (105) on impact and can be adjusted as described above, exerts a spring force on the rod (103) and the handle element (101) firmly connected to it.

Weitere Ziele, Merkmale und Anwendungsmöglichkeiten ergeben sich aus der nachfolgenden Beschreibung von die Erfindung nicht einschränkenden Ausführungsbeispielen anhand der Figuren. Dabei bilden alle beschriebenen und/oder bildlich dargestellten Merkmalen für sich oder in beliebiger Kombination den Gegenstand der Erfindung. Es zeigen:

Further objectives, features and possible applications are shown in the following description of non-limiting embodiments of the invention with reference to the figures. All the features described and/or illustrated form the object of the invention either individually or in any combination. The figures show

### BRIEF DESCRIPTION OF THE DRAWINGS

FIG. 1 a schematic illustration of the tool 1 according to the invention in a preferred embodiment in the pulled-apart state,

FIG. 2 a schematic illustration of the tool 1 according to the invention from FIG. 1 in the pushed-together state,

FIG. 3 a schematic partial sectional view of the tool 1 according to the invention from FIG. 1,

FIG. 4 a schematic illustration of the tool 1 according to the invention from FIG. 1 in the pushed-together state and

FIG. 5 a schematic sectional view of the tool 1 according to the invention from FIG. 1.

Identical parts have the same reference signs in all figures, but for reasons of clarity not all parts are labelled with reference signs in all figures.

### DETAILED DESCRIPTION OF THE INVENTION

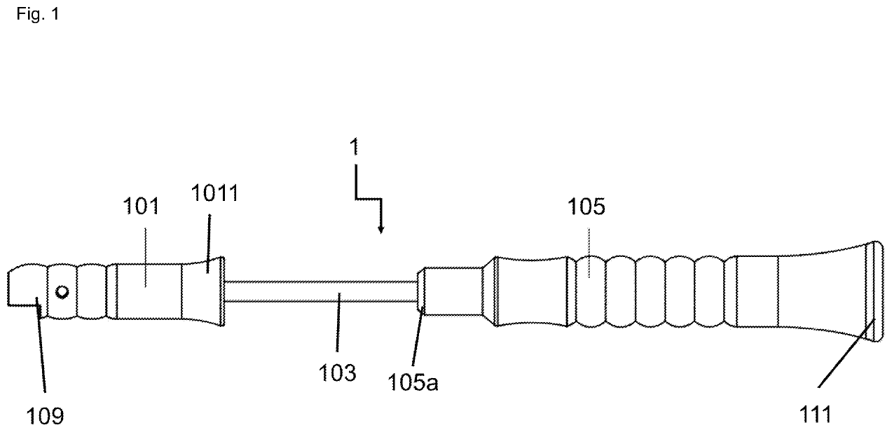

In FIG. 1, the tool 1 according to the invention is shown schematically in a preferred embodiment in the pulled-apart state. The handle element 101 has a rod 103 which is fixedly received therein and which is slidingly mounted in the weight 105 at the opposite end. A receiving device 109 is arranged at the outer end of the handle element 101, which serves to receive processing inserts. The end facing the weight 105 has a funnel-shaped widening 1011, which provides a better grip for the hand and at the same time makes it easier to hold the conical end of the weight 105.

If the weight 105 is moved away from the handle element 101 in a swinging motion, a directional movement acts in the weight 105 when it strikes against the second stop 103a, which utilises the tool 1 as a rebound hammer. If, on the other hand, the weight 105 is moved in a swinging motion back towards the handle element 101, a directional movement acts when striking against the first stop 101a, which makes the tool 1 usable as a guided impact hammer or chisel. The work of the tool 1 according to the invention is performed at the moment the weight 105 strikes one of the stops 101a, 103a.

While the use described above is aimed at two-handed operation, in another embodiment the tool 1 according to the invention also enables one-handed operation, in particular during dent removal. For this purpose, the tool 1 according to the invention is held by the weight 105 with one hand, with the funnel-shaped widening 1011 serving here as a recessed grip for the thumb.

For use, the tool 1 according to the invention is applied to the area to be dented out with a processing insert arranged on the receiving device 109. The weight 105 is then moved away from the area to be dented out. The spring 107 builds up a spring force which, when a pre-adjustable level is reached, causes the handle element 101 to spring back and thus a bulging force on the processing insert. This additional function according to the invention enables the operator to catch the handle element 101 with the thumb again and immediately reattach the tool 1 according to the invention in the starting position.

The one-handed operation is particularly important in the practice of dent removal, as the surface of the sheet metal to be dented out is simultaneously observed flat in the grazing light during processing in order to check the success of the work. This simultaneous observation with grazing light and the use of a conventional pulling hammer has not been possible up to now due to the necessary two-handed operation or has only been possible for very mobile persons. The present invention with the new possibility of one-handed operation makes it possible for the first time to work on a long outstretched arm with one hand.

The newly created possibility of one-handed operability according to the invention is created by three features of the present invention
the wide “immersion” of the weight 105 into the funnel-shaped widening 1011 of the handle element 101,
the retraction of the handle element 101 by the spring 107,
the ergonomically thumb-friendly funnel-shaped extension 1011 as a kind of “safety catch”.

In order to make it easier to set down the tool 1 according to the invention and to ensure a secure stand, the outer end of the weight 105 has a closed flat end 111. In order to avoid damage, a rubber coating can be applied there.

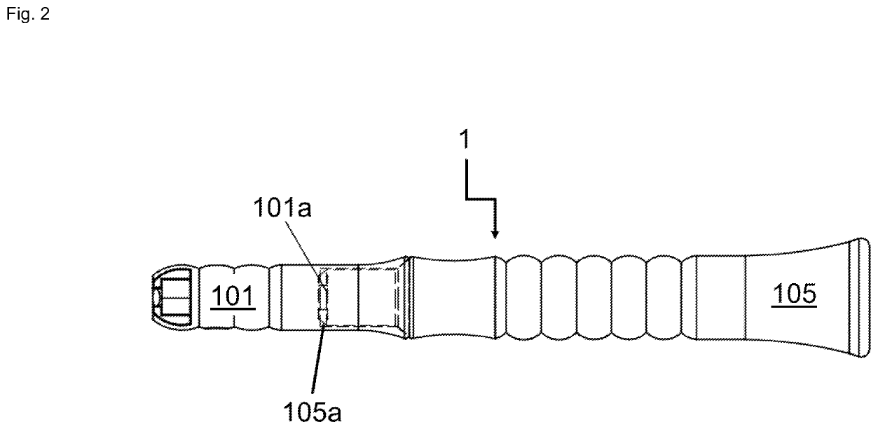

A schematic illustration of the tool 1 according to the invention from FIG. 1 in the pushed-together state is shown in FIG. 2. The fact that the front part of the weight 105 runs into the funnel-shaped widening 1011 of the handle element 101 reduces the external dimensions of the tool 1 according to the invention, which makes it easier to handle in use. This figure clearly shows how the stops 101a, 105a, which are used for the hammer function, are concealed in order to significantly increase protection against injury. The stops 101a, 105a are not accessible from the outside.

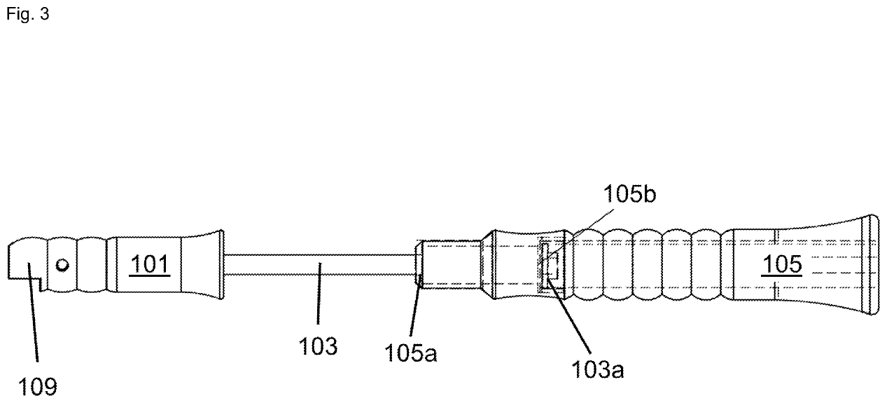

FIG. 3 schematically shows a partial cross-section of the weight 105, in particular the arrangement of the second stop 103a and the fourth stop 105b, which are used for the function as a pulling hammer. These two stops 103a, 105b are also concealed to minimise the risk of injury.

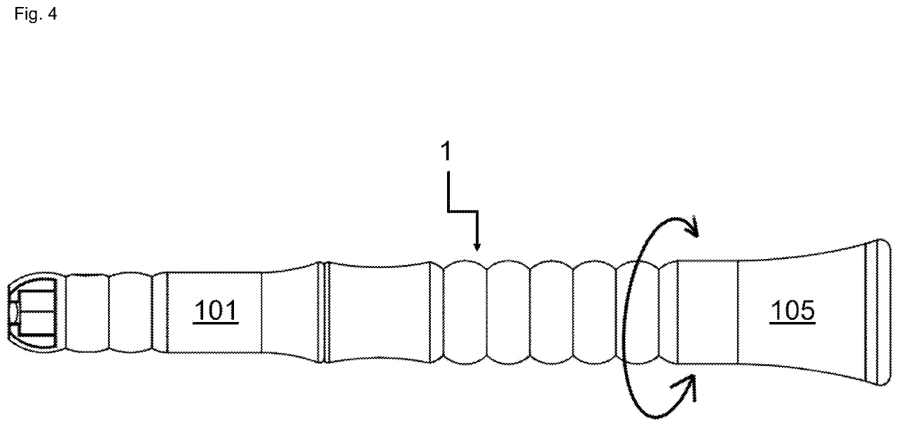

FIG. 4 schematically illustrates the adjustment of the pretension of the spring 107. This can be achieved simply by turning the weight 105 relative to the handle element 101, whereby both hands can remain on the respective elements and no additional hand tools are required. This adjustability can therefore be set directly on the weight 105 without interrupting work.

The hardness on the fourth stop 105b can be cushioned by the spring 107 to influence the impact effect. This stop spring 107 is infinitely pretensioned for this purpose and thus the stop hardness is adjusted.

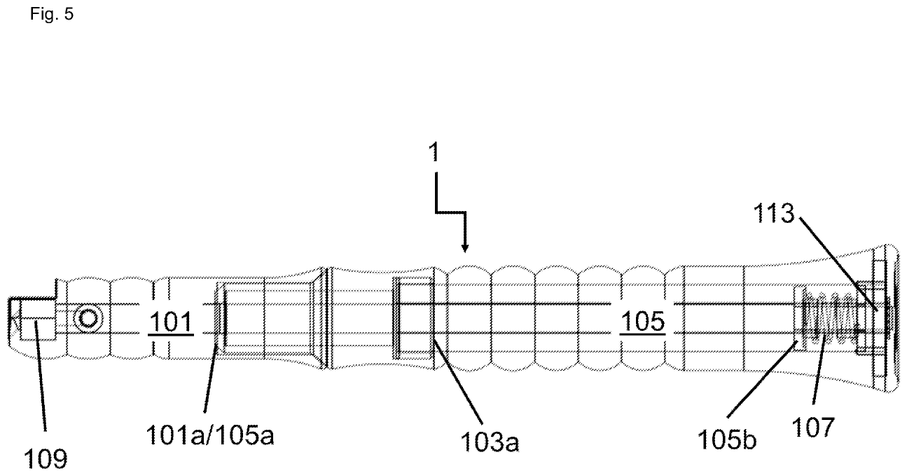

FIG. 5 shows a schematic sectional view of the tool 1 according to the invention. In particular, the spring 107 is shown here, which presses against the end of the rod 103 with the stops 103a, 105b. A nut 113 is provided at the outer end, which has a lug which is guided in a groove, not shown, around the inside of the weight 105. The nut is mounted in the groove so that it cannot rotate, which makes it possible to adjust the pretension of the spring 107 purely by turning the weight 105.

As already shown above, the tool 1 according to the invention has a combined impact and pulling function in a special embodiment.

In vehicles, especially on bonnets and under roofs, there are usually bows and beams to stabilise the upper panels, some of which are flexibly bonded to the underside of the upper panel with a very strong adhesive. To remove dents from the upper panel, these putties or bondings often have to be cut open and removed.

According to the state of the art, there is no suitable solution for this apart from hand-operated long knives. These long knives are very difficult to drive into the cementing or bonding and often get stuck due to the elasticity of the material.

In the special embodiment, a very flexible knife blade (similar to a bayonet) is placed on the front of the receiving device 109 of the tool 1 according to the invention instead of a pure impact attachment or a pure pulling attachment. The knife can now be easily rubbed through the cementing or bonding even through the smallest of openings with little effort and with little space to work and also in unfavourable positions using the impact function, because the hard impulses of the impact side are sufficient with little force. When the knife is stuck in the cementing or bonding putty, the knife can be pulled out again using the pull function with simple backward impulses. The dual function of the tool 1 according to the invention can be utilised here in a single operation.

### BEZUGSZEICHENLISTE

1 tool
101 handle element
101a first stop
1011 funnel-shaped widening
103 rod
103a second stop
105 weight
105a third stop
105b fourth stop
107 spring
109 receiving device
111 closed flat end
113 nut

1. A tool (1) comprising
a handle element (101),
a rod (103) which is firmly received in the handle element (101) and has a second stop (103a) at its end opposite the handle element (101),
a weight (105) slidingly guided on the rod (103), which has a third stop (105a) on its side facing the handle element (101) and a fourth stop (105b) in its interior,
wherein the handle element (101) has a first stop (101a) at its end facing the weight (105), so that the weight (105) can be struck with its third stop (105a) against the first stop (101a) and alternatively with its fourth stop (105b) against the second stop (103a).

2. The tool (1) according to claim 1, wherein the first stop (101a) is concealed inside the handle element (101).

3. The tool (1) according to claim 1, wherein the weight (105) is tapered on its side facing the grip element (101), so that it is at least partially received in a recess of the grip element (101) when it strikes the first stop (101a).

4. The tool (1) according to claim 1, further comprises a spring (107) which is accommodated inside the weight (105), the pretension of the spring (107) being adjustable for the impact hardness of the weight (105) by rotating the weight (105).

5. The tool (1) according to claim 1, wherein the handle element (101) has a funnel-shaped widening (1011) at its end facing the weight (105).

6. The tool (1) according to claim 1, further comprises a receiving device (109) arranged on the handle element (101), which is orientated towards a workpiece to be treated.

7. The tool (1) according to claim 6, wherein the receiving device (109) accommodates processing inserts which can be attached to contact points of a structure to be dented in order to transmit force from the tool (1) according to the invention, so that the tool (1) acts as a pulling hammer.

8. The tool (1) according to claim 6, wherein the receiving device (109) accommodates processing inserts which can be attached to a structure to be deformed in order to transmit force from the tool (1), so that the tool (1) acts as a hammer.

9. The tool (1) according to claim 6, wherein the receiving device (109) accommodates a processing insert designed as a flexible knife, which is designed to be inserted into a bond or cementing between two body parts by means of the impact function and pulled out again by means of the pulling function, so that the bond or cementing can be released.

10. The tool (1) according to claim 1, wherein the weight (105) has linear ball bearings in order to slide on the rod (103) with optimised friction.

11. The tool (1) according to claim 1, wherein the tool (1) has a closed flat end (111) at the outer end of the weight (105).

12. The tool (1) according to claim 11, wherein the closed flat end (111) of the weight (105) widened in the shape of a funnel.

13. The tool (1) according to claim 11, wherein the closed flat end (111) has a rubber coating.
